(19) United States
(12) Patent Application Publication
(10) Pub. No.: US 2009/0178940 A1
(43) Pub. Date: Jul. 16, 2009

(54) STACKED-CONTAINER REUSABLE BOTTLE, SYSTEM AND METHOD PROVIDING FLEXIBLE USE AND MIXING

(76) Inventor: Jose E. Said, Orlando, FL (US)

Correspondence Address: FERDINAND M. ROMANO, ESQUIRE;BEUSSE WOLTER SANKS MORA & MAIRE, P.A., SUITE 2500, 390 NORTH ORANGE AVENUE, ORLANDO, FL, 32801, US

(21) Appl. No.: 12/351,580

(22) Filed: Jan. 9, 2009

Related U.S. Application Data
(60) Provisional application No. 61/020,240, filed on Jan. 10, 2008.

(51) Int. Cl. B65D 25/08; A61J 11/00

(52) U.S. Cl. 206/221; 215/11.1; 215/DIG. 8

(57) ABSTRACT

A multi-chambered container assembly including a two-piece adapter having a base and a hollow member that cooperate to open and close a passage between a first chamber provided by a bottle and a second chamber formed in the hollow member. The base defines a first opening and has a substantially semi-spherical concave wall surrounding the first opening, and the hollow member includes a substantially semi-spherical convex wall that pivotally (slidably) fits within the concave wall of the base. The hollow member is snap-coupled to the base using a pair of pins and a pair of cam grooves that facilitate movement of the hollow member between a closed (first) position and an open (second) position. The base can be integrally formed onto the bottle to provide a two-piece multi-chambered container.

### RELATED APPLICATION

This application claims priority to provisional patent application U.S. 61/020,240 filed Jan. 10, 2008 which is incorporated herein by reference in the entirety.

### BACKGROUND OF THE INVENTION

1. Field of the Invention

This invention relates to a stacked-container reusable bottle adapted to contain a liquid in a first upper container, a dry material in a second lower container, and an intermediate coupler reversibly connecting the upper and lower containers, arranged so as to provide for flexible uses and mixing options.

2. Discussion of Prior Art

One of the most common ways of consuming nutritional drinks involves mixing a powdered formula with a liquid in a bottle or other container. Predetermined amounts of a powdered formula may be added to a liquid such as water, followed by shaking or stirring both components until obtaining a suitably uniform and consistent mixture. Due to the perishable nature of some mixtures, it is necessary to either immediately consume the mixture or refrigerate it for later consumption.

Conventionally, this process has required use of two storage containers, one to store the liquid and the other to store a powder-like substance or another liquid until mixing. Moving the material from one container to the other container, or even to a third and final container, can subject the product to contamination, particularly during transfer between containers and when mixing. Another disadvantage has been the need to provide sufficient physical space when mixing the materials. Otherwise, spillage or incorrect mixing quantities may result, e.g., especially when level surfaces and suitable measuring devices are not available. In the past several designs of multi-chamber containers have been developed to address such disadvantages. See, for example, U.S. Pat. No. 2,793,776, U.S. Pat. No. 2,807,384, U.S. Pat. No. 2,813,649, U.S. Pat. No. 5,678,709 and U.S. Pat. No. 6,920,991. Such prior designs are known to include two chambers joined by a narrow channel that is blocked by an axially-displaced seal or a seal punctured by an axially-displaced plunger. A problem with these designs appears to be that the relatively narrow channel between the two chambers renders a thorough mixing difficult. Axially-displaced seals and incorporation of a plunger can impede the mixing process. It is also desirable to avoid inclusion of a large number of parts and mechanical mechanisms that can cause the apparatus to be complex, costly to manufacture and above a suitable price point for large volume production. In addition to these drawbacks, some of the prior designs are complicated to operate requiring, for example, loosening and tightening of a locking collar to effect rotation of a hollow member between the first and second positions. Moreover, because the locking collar must fit over the neck of the hollow member, the diameter of the hollow member neck is smaller than the diameter of the locking collar. This reduces the diameter of the opening through which substances are to be inserted into the hollow member.

Notwithstanding the above, there remains a need in the art for a container and a container system that provides for flexible mixing and storage of both the separable materials and the mixed liquid resulting after the separated materials are combined.

### BRIEF DESCRIPTION OF THE DRAWINGS

FIG. 1 is a perspective side view taken along a central axis of a stacked-container infant bottle according to one embodiment of the present invention;

FIG. 2 is an exploded perspective view of the embodiment of FIG. 1;

FIG. 3A is an enlarged perspective view of a sub-combination of components shown in FIG. 1, including a lower container press fit to an intermediate coupler;

FIG. 3B provides a partially exploded side perspective view of the sub-combination depicted in FIG. 3A, illustrating an exemplary position-locking mechanism;

FIG. 4 is a partial cross-sectional side view of the embodiment of FIG. 1 taken along the central axis;

FIG. 5A is another partial cross-sectional side view of the embodiment of FIG. 1, also taken along the central axis;

FIG. 5B is an enlargement of a portion of the view of FIG. 5A showing the seating of a seal member;

FIG. 6 is a view in cross section, taken along the central axis, of a lower container press fit with an intermediate coupler according to the embodiment of FIG. 1;

FIG. 7 is a perspective side view of an embodiment of a sports capped stacked-container bottle according to another embodiment of the invention;

FIGS. 8A-F are perspective views which schematically illustrate a first method of use of a stacked-container bottle and system according to the invention;

FIGS. 9A-E are perspective views which schematically illustrate a second method of use of a stacked-container bottle and system according to the invention;

FIG. 10A provides a view in cross section, taken in the direction of the central axis shown in FIG. 1, of apertures of a lower container and an intermediate coupler rotated into alignment;

FIG. 10B provides a view in cross section taken in the direction of the central axis shown in FIG. 1 of aligned apertures according to an alternate embodiment of the invention; and

FIG. 11 provides a perspective side view of the stacked-container infant bottle according to FIG. 1, also taken along the central axis, illustrating a lower container configured to receive a screw-on bottom cap.

### DETAILED DESCRIPTION OF EMBODIMENTS OF THE INVENTION

Embodiments according to the invention include a stacked-container reusable bottle adapted to contain, prior to a mixing step, a liquid in a first upper container and a dry material in a second lower container, and comprising an apertured intermediate coupler adapted to reversibly connect the two containers in a stacked manner. A feature of these embodiments is that both solid and liquid materials can be retained in isolation from one another and one of the materials can be dispensed without disturbing the other material. For example, the illustrated embodiments enable filling of the container with both a large volume of liquid, e.g., water, and a smaller volume of liquid or dry mix, and permitting a user to dispense the liquid without first combining any of the smaller volume of liquid or dry mix with the large volume of liquid. For example, when a container is more or less in a vertical, upright position, with the dispensing portion, e.g., a nipple, above the portions of the container which store the large volume of liquid and the dry mix, it is possible to dispense the large volume of liquid without disturbing the dry mix. The disclosed arrangement of components enables selective provision of the liquid in two manners. Contents within an upper container may be delivered directly to a user, or the contents within the upper container can first be mixed with the dry material in the upper container only, or first be mixed in both the upper and the lower containers. Apertures in the intermediate coupler are rotatable relative to apertures in one of the lower container or the upper container to either maintain a closure that prevents mixing or to provide at least one open passage between the upper and the lower containers. The invention may be embodied as the stacked-container reusable bottle, as a system that provides for flexible use of the bottle and optionally including a plurality of intermediate couplers 40 each attached to a lower container 60 to separately store multiple liquid or dry mixes. With this arrangement it is possible to prepare multiple measured amounts of dry or liquid mix and later sequentially 2attach the pairs of couplers 40 and lower containers 60 to upper containers 20. Various embodiments of the present invention provide for sufficiently large container volumes for both the liquid in the upper container, the dry material in the lower container, and for mixing the liquid with the dry material either in the upper container or simultaneously in both containers.

According to still other embodiments of the invention, the intermediate coupler may be attached, such as by press fitting, onto either the upper or the lower container, and then remain reversibly attachable, such as by turning of a threaded fitting, to the other of the upper and lower containers. Such affixed combinations comprise sub-combinations of the stacked-container bottle of which it forms a part.

In various embodiments the present invention may be used for feeding infants, as a sports beverage bottle, or as a container-dispenser system for mixing two volumes of chemicals wherein at least one is a liquid volume. In some embodiments, such as when used as a ‘baby bottle’ to feed infants, a time-tracking device may be integrally incorporated to indicate, for example, when the liquid and dry material were mixed, or a desired time for dispensing the contents. This may be important in order to assure feeding of infants with relatively fresh quantities of formula. Thus, in some embodiments the time tracking device comprises a movable ring over imprinted numbers indicating time of day or a time interval, useful to record when the mixing of the two pre-metered substances occurred and providing an easily readable display to monitor age of perishable preparations for the safety of the consumer.

Consumers are in need of simple but useful container system design to save time without sacrificing the quality, freshness and safety of the preparation. As a sports beverage type bottle for children and adults who wish to drink liquids fortified with various powdered materials, such as protein mixes, embodiments of the present invention allow for flexible use of the bottle. That is, a user may drink only the liquid for a desired period, and then, when mixing is desired, open the apertured intermediate coupler to mix the remaining (or replenished) liquid with liquid or dry material in the lower container. As will be described herein, the method of mixing may be either to mix in the upper container or in both containers. The invention provides for independent access to either container.

Bottle embodiments of the present invention comprise components that are simple to assemble, simple to operate, and easy to clean between uses. Also, based on the innovative design, the manufacturing costs are reasonable for the benefits obtained.

The following discussion, with reference to the appended drawings, describes exemplary embodiments of the present invention, but are not meant to be limiting of the scope of the invention. Also, it is appreciated that although the liquid used may be water, it may alternatively be milk, or a juice, or other liquid (in some embodiments including a chemical solution to be mixed with a dry material from the lower container).

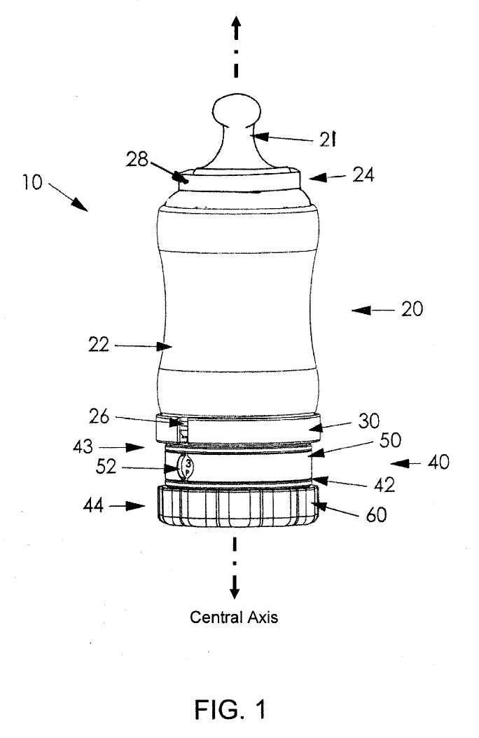

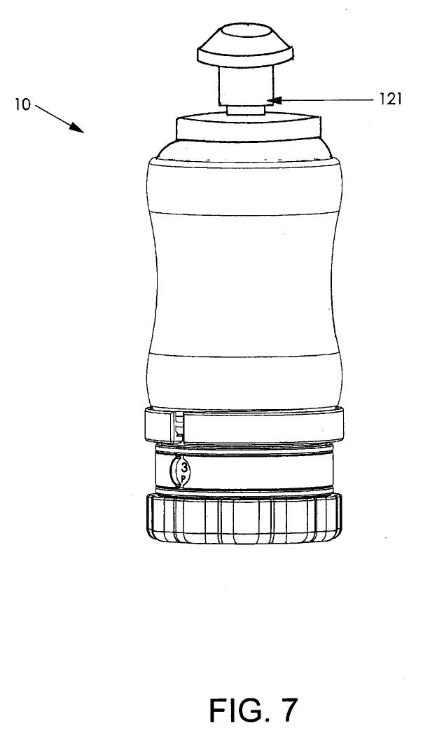

FIGS. 1 and 7 provide perspective side views of two embodiments of the stacked-container bottles 10 of the present invention. The stacked-container bottle 10 of FIG. 1 comprises as its dispensing portion a top cap 28 in which a dispensing outlet, i.e., a rubber nipple 21, is attached for use of the container as a baby or infant bottle. The bottle of FIG. 1 also includes an exemplary time tracking device. The stacked-container bottle 10 of FIG. 7 comprises as its dispensing outlet a sports cap 121 rendering the bottle suitable in activities where a flexible use and mixing of liquids or liquid and dry material is desired. Apart from the presence of the rubber nipple 21 and the description of certain methods of use for feeding an infant, the following discussion of the structure and operation of the exemplary embodiment of FIG. 1 may be applied to the embodiment of FIG. 7.

The stacked-container bottle 10 shown in FIG. 1 comprises an upper container 20, an intermediate coupler 30, and a lower container 40. These are shown in a conventional upright position with respect to a Central Axis such that the nipple and top cap are above the upper container, the upper container is above the coupler 30 and the coupler 30 is above the lower container 40. Thus the upper container is next to the top cap 28 which provides the dispensing portion while the lower container is separated from the dispensing portion such that contents therein can be confined while contents of the upper container are dispensed. While the upper container 20 may in some embodiments be of unitary construction, in the embodiment of FIG. 1 the upper container 20 is comprised of a generally cylindrical body 22 having a top end 24 and a bottom threaded end 26. When the bottle 10 is fully assembled, in addition to being a dispensing portion of the bottle, the combination of the top cap 28 and the rubber nipple 21 is positioned therein also may be considered functionally part of the upper container 20. The top cap 28 may be attached to the cylindrical body 22 by a threaded or other reversible attachment arrangement. The upper container 20 is adapted to hold a volume of liquid (not shown in FIG. 1) which may be added either by unscrewing the top cap 28 or by inverting the upper container 20, filling it with a desired liquid volume, and then screwing the intermediate coupler 30 onto it.

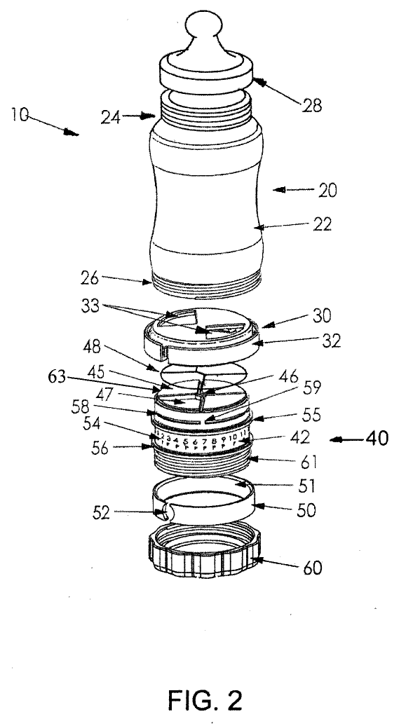

Similarly, while the lower container 40 may in some embodiments be of unitary construction, in the embodiment of FIG. 1 the lower container 40 is comprised of a cylindrical body 42 having a top end 43 and a bottom threaded end 44, and to which is attached a bottom cap 60. See also FIG. 2. The lower container 40 may receive a liquid or a dry mix of material (not shown in FIG. 1) through the bottom threaded end 44 over which the cap 60 is attached by screwing the cap 60 onto threads positioned on the end 44 along the outside of the cylindrical body 42. This provides a bottom for the lower container 40. Alternately, the mix may be inserted into the container through one or more top surface apertures described herein. A time indicator ring device 50, exemplary of a time tracking device, is positioned around the cylindrical body 42 of the lower container 40 and may be rotated to record the time at which mixing takes place. The recorded time is viewable in a time indicator window 52.

As described in detail below, the intermediate coupler 30 is affixed to rotate upon the lower container 40 at its top end 43. By rotating the intermediate coupler 30 to specific positions in relation to the lower container 40, there is either a passage between the upper container 20 and the lower container 40, or there is a seal, i.e., no passage, the latter position providing a barrier to passage of liquid or dry material.

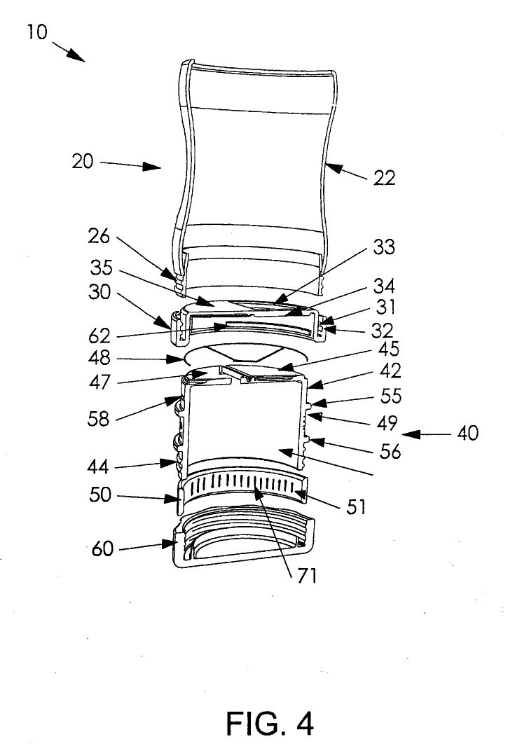

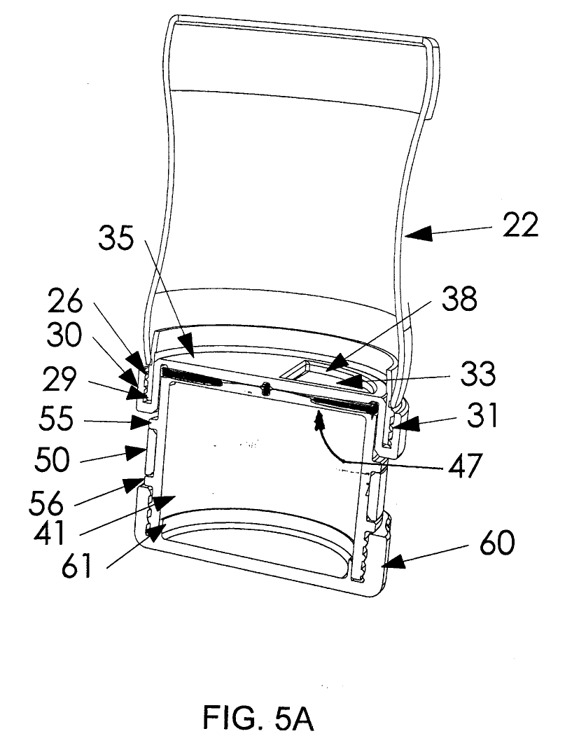

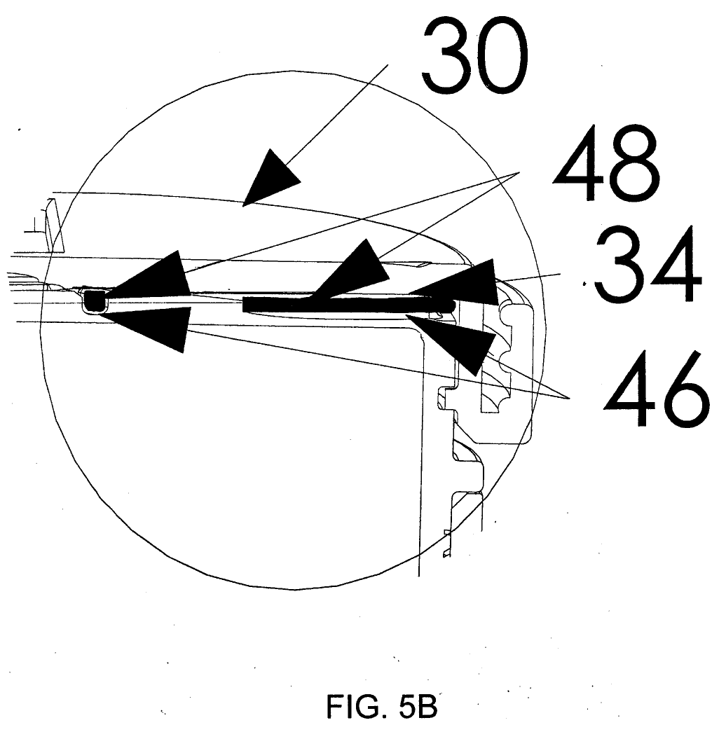

FIG. 2 illustrates, in an exploded view of the stacked-container bottle 10 of FIG. 1, additional components and features of the embodiment. Along a disk-shaped top surface or plate 45 of the lower container 40 a seal member groove 46 is formed in a pattern around the perimeter 63 of the top surface 45 and also around two top surface apertures 47 formed in the top surface 45. A seal member 48 is shown above the seal member groove 46. In assembled position the seal member 48, which may be an appropriately shaped O-ring of suitable hypoallergenic silicone or other flexible material, is seated in the groove and further extends outward from the groove to provide a sealing function around the top surface apertures 47. See also FIG. 4 and FIG. 5B which illustrate screw-type threads 31 positioned inside an outer partition 32 of the intermediate coupler 30. Referring again to FIG. 2, these threads 31 are sized to receive the threaded bottom end 26 of the upper container 20 to effect a screw closure-type readily reversible attachment as depicted for the fully assembled bottle 10 shown in FIG. 1. Two intermediate coupler apertures 33, formed through a rotatable plate 35, each have a generally triangular shape similar to the top surface apertures 47. Other geometric shapes are contemplated.

Also viewable in FIG. 2 are imprinted indicia 54 comprising a series of numbers or letters indicating hours of the day. As noted above, the time indicator ring device 50 may be rotated to display through the indicator window 52 a number designating the time of mixing, the maximum time for use, etc. Serrations or other surface friction and positioning features may be provided on the outer surface of the lower container 40, between an upper guide 55 and a lower guide 56, and/or on an inside surface 51 of the time indicator ring device 50, to provide for controlled movement with, for example, friction to which maintain the display in a desired position.

The intermediate coupler 30 is attachable to the lower container 40 such that the intermediate coupler, relative to the lower container, may be made to rotate within a specified range, e.g., about the Central Axis. A lateral groove 58 extends along the outside of the lower container 40 parallel to and a predetermined distance from the top surface 45. Along this groove are spaced apart stops 59, one of which is shown in FIG. 2. Referring now to FIG. 4, on the inside of intermediate coupler 30 there are spaced apart linear protrusions referred to as coupler guides 62. In an assembly step, the intermediate coupler 30 is press fit about the lower container 40 so that the coupler guides 62 align with and enter the lateral groove 58 between the stops 59. This press fit, given the referred to predetermined distance and the thickness of the seal member 48, results in a compression of the seal member 48 between the top surface 45 of the lower container 40 and a bottom surface 34 of the intermediate coupler 30. So affixed, the intermediate coupler 30 may rotate within a specified range to allow both for complete alignment of the apertures 33 and 47 and also for complete non-alignment. This press fit of the stated components is not meant to be limiting, as there are other ways known to those skilled in the art to achieve a sealed rotatable arrangement between the intermediate coupler and one of the upper and the lower containers 20 and 40.

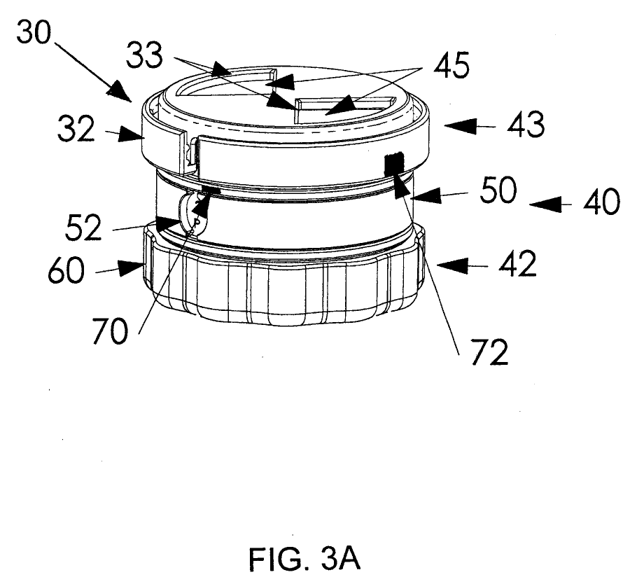

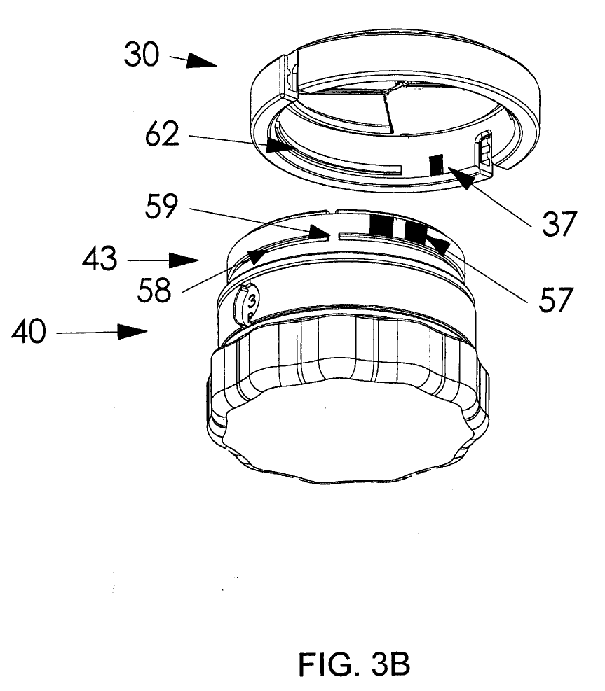

FIG. 3A is a perspective view showing intermediate coupler 30 press fit over the lower container 40, prior to attachment to an upper container 20. In a kit of the present invention, a plurality of such components may be provided (see FIG. 7) so that a number of these subcomponent assemblies, i.e., pairs each comprising the lower container 40 with the intermediate coupler 30 attached thereto, may be used for preparing a plurality of measured doses of mixing material that are sequentially used by attachment to an upper container that is made to contain a liquid to be mixed with the dry material. During storage, the lower container 40 is sealed by positioning of the intermediate coupler apertures 33 directly over the top surface 45 rather than over the top surface apertures. Positioning marks 70 and 72, when aligned, may either indicate a center position for full alignment of the apertures 33 and 47 to form the passage or, as shown in the figure, the position of aperture 33 which corresponds to complete closure of the passage, i.e., when the aperture 33 is fully placed over the surface 45 to effect a “closed” position. Appropriate words, letters, or symbols may be used for or with such positioning marks to indicate the open or closed state of the passage(s).

FIG. 3B provides a partially exploded side perspective view of the sub-combination depicted in FIG. 3A, revealing a type of position-locking mechanism. Along top end 43 are provided two closely spaced apart protrusions 57, and a single protrusion 37 is provided along an interior wall of the intermediate coupler 30. The sizes of the protrusions 57 and 37 are such that when press fit as shown in FIG. 3A, the single protrusion 37 may slide over one of the spaced apart protrusions 57 to a position between the two closely spaced apart protrusions 57. This provides a locking mechanism to keep the passage(s) open or closed. It also provides an ability to sense when the intermediate coupler apertures 33 are aligned (to provide a passage) or not aligned (to provide closure) with the top surface apertures 47 (not shown, see FIG. 2 et al.). Variations of this arrangement will be apparent. For example, when a position locking and/or indicating mechanism is provided at the end of the rotational limits based on the arrangement of the coupler guide 62 and the stop(s) 59, only one protrusion 57 with the single protrusion 37 may be sufficient since the stop 59 would cause the end of the rotational movement beyond a specified rotational distance. Also, the combination may comprise one protrusion and one recess rather than two or three protrusions.

FIG. 4, is a view in cross-section of the bottle 10 shown in FIG. 1. Serrations 71 are provided along the inside surface 51 of the ring device 50 to provide for an adjustable rotation of the indicator ring device to a desired position from which it will not readily move. FIG. 4 also shows an upper guide 55 and a lower guide 56 that extend outward from an outer surface 49 of lower container 40 creating a guide that facilitates turning of the indicator ring device 50, allowing the latter to be turned so the indicator window 52 is positioned over a desired time (number) indicating, for example, the time when the mixing of both substances took place.

FIG. 5A is a partial view in cross section of the stacked-container bottle 10 of FIG. 1 in an assembled arrangement. The threaded lower end 26 of upper container 20 is shown threaded along the threads 31 on intermediate coupler 30. This threading arrangement in combination with a sealing edge 29 at the bottom-most portion of the lower threaded end 26 is effective to provide a seal to prevent the loss of liquids. Such sealing edges are known to those skilled in the art. In alternative embodiments a flexible seal may alternatively or additionally be employed for this sealing. Also, this figure shows the alignment of intermediate coupler apertures 33 and top surface apertures 47 to provide a passage for materials between the upper and lower containers 20 and 40.

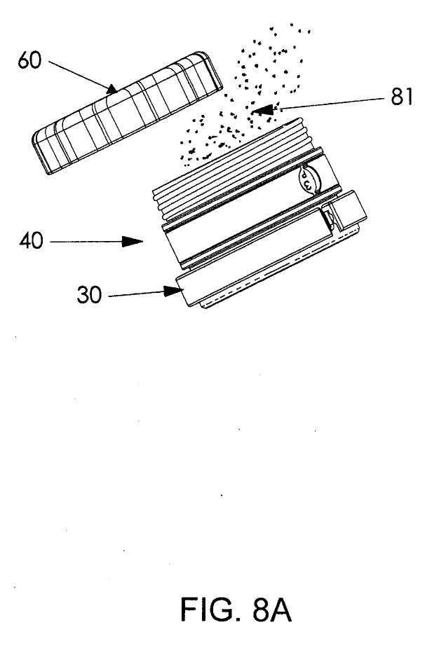

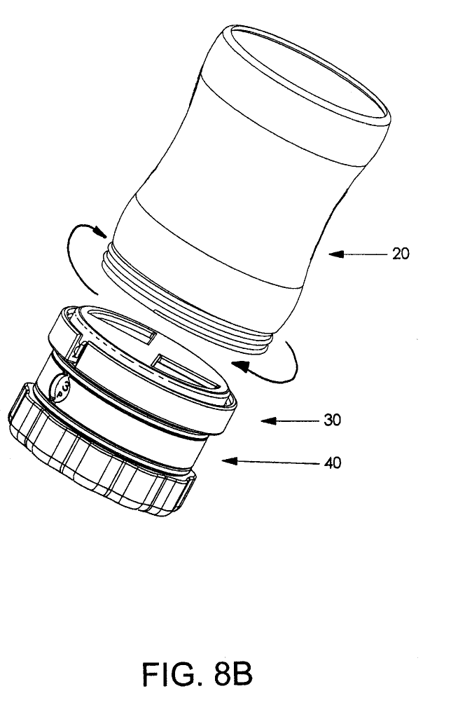

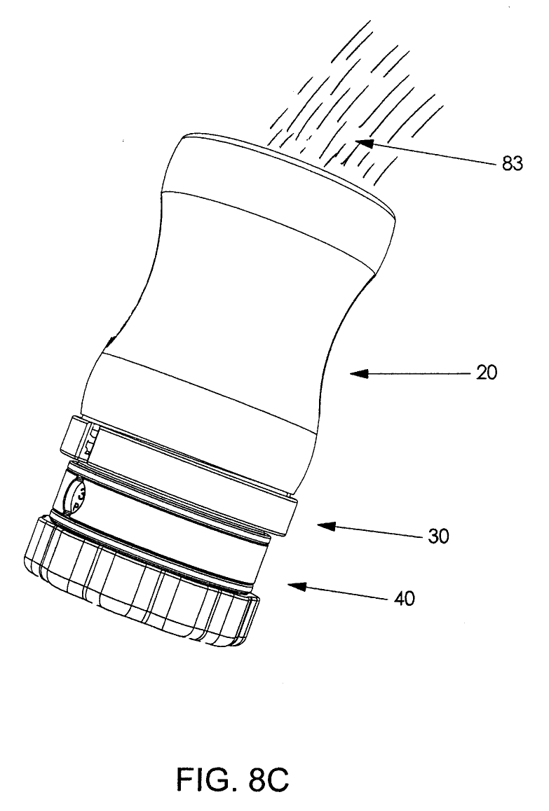

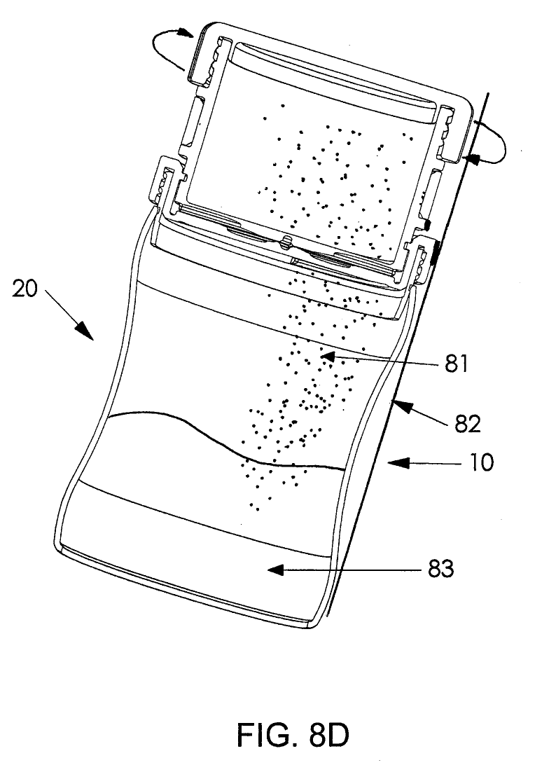

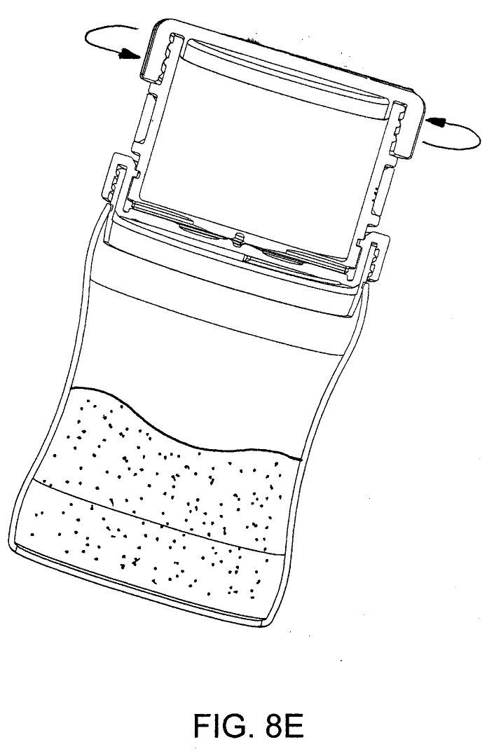

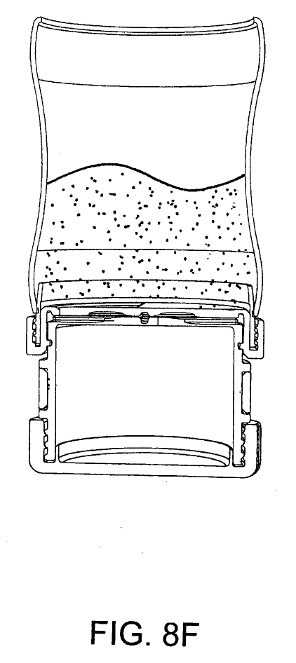

A seal member 61 extends upward as a part of bottom cap 60. This provides a sealing press fit against an inner wall 41 of the lower container 40 to provide an effective seal against loss of liquids through the junction formed between lower container 40 and bottom cap 60. Also, in the embodiment depicted in the figure the inner wall 40 is aligned with the outer border 38 of aperture 33 (and also with the analogous outer border of aperture 47, which is not shown in FIG. 5A. When so advantageously aligned (or, alternatively, when positioned further radially inward), and when the method described in FIGS. 8A-F is employed, there is a more facile flow of dry material without hang-up of the same along the edges that would otherwise form within lower container 40.

FIG. 5B provides an enlarged view of a portion of the bottle 10 shown in FIG. 5A. Seal member 48 is shown seated in the groove 46, with a portion of the seal member 48 extending outward from the groove 46 to press against the bottom surface 34 of intermediate coupler 30. This provides for stable positioning of the seal to effect a rotatable and effective seal arrangement which prevents liquid placed in one of the containers 20 or 40 from passing into the other of the containers 20 or 40. The groove 46 and the seal member 48 each extend along both the perimeter 63 of the top surface 45 and the top surface apertures 47.

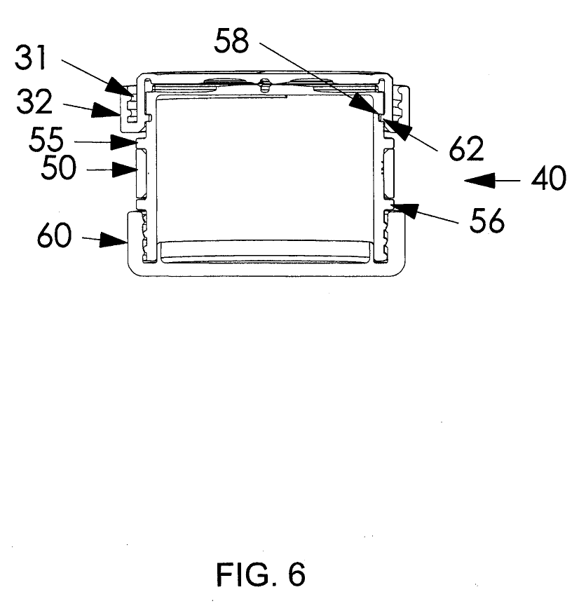

FIG. 6 provides a view in cross section of the sub-combination of the intermediate coupler 30 press fit with the lower container 40. This view illustrates engaged arrangement of the coupler guide 62 of the intermediate coupler inside the lateral groove 58 of the lower container 40. As noted above, this provides for a rotating movement constrained by the stops 59 shown in FIG. 2.

FIG. 7 is a perspective view of another embodiment of the stacked-container bottle 10 having, as its dispensing outlet, a sports cap 121. This embodiment may be used in numerous activities where there is a periodic need to mix together a dry material, such as a protein powder mix, with a liquid while engaged in an activity not convenient to and/or near a kitchen or refrigerator. Although no time tracking device, such as depicted in FIG. 1, is provided in this illustration, any type of time tracking or other record keeping device may be incorporated.

The stacked-container bottle embodiments of the present invention lend themselves to flexible operation. For example, dry mixing material may be mixed with the liquid without wetting the lower container. FIGS. 8A-8F exemplify this. In FIG. 8A, a dry material 81 is added to an intermediate coupler 30/lower container 40 sub-combination which has been rotated to a closed position. Then the cap 60 is screwed on to close the bottom of the lower container. In the partial view of FIG. 8B the upper container 20 may be rotated about the Central Axis to effect being screwed onto the intermediate coupler 30. Then, when in an upright position, as shown in FIG. 8C, a desired liquid 83 is added to the upper container 20. The top is then sealed (not shown), such as by threading on a desired top with a dispenser. See FIGS. 1 and 7 as examples. Then at the desired time of mixing the so-assembled stacked-container bottle 10 is inverted to a position at which a top surface aperture is centered along a line 82 extending along the exterior of the bottle 10. Then, holding the lower container 40 with one hand in this position, the upper container 20 and the intermediate coupler 30 are rotated to align an intermediate coupler aperture with that top surface aperture to open a passage and permit by gravity the dry material 81 to fall into the upper container 20 and mix with the liquid 83. This is shown in FIG. 8D. Markings along the exterior surfaces of the bottle 10 may provide guidance as to the position of the top surface apertures, and open and closed arrangements between these and the intermediate coupler apertures.

FIG. 8E shows an arrow indicating a relative twisting to close the passage formed in the previous step. Also shown is the mixing of dry material 81 with liquid 93 in the upper container 20 while the bottle 10 still is inverted. As shown in FIG. 8F, once the passage is closed (see FIG. 3A), the bottle 10 may be rotated to an upright position and the liquid 83, now with the dry material 81 dissolved or in suspension or other state, may be dispensed or held for a period.

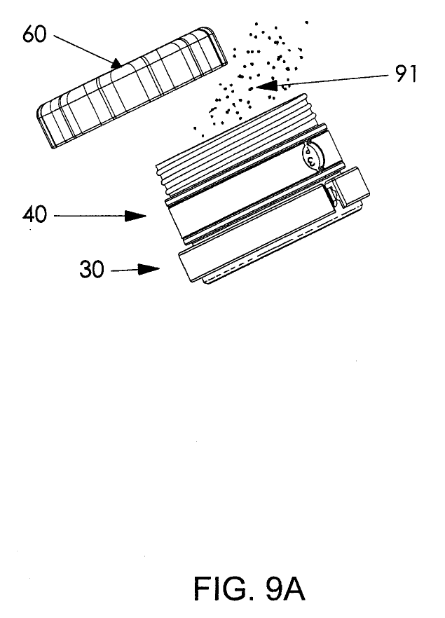

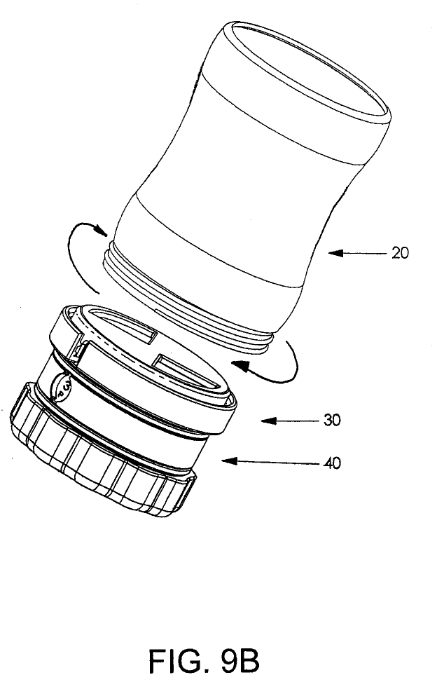

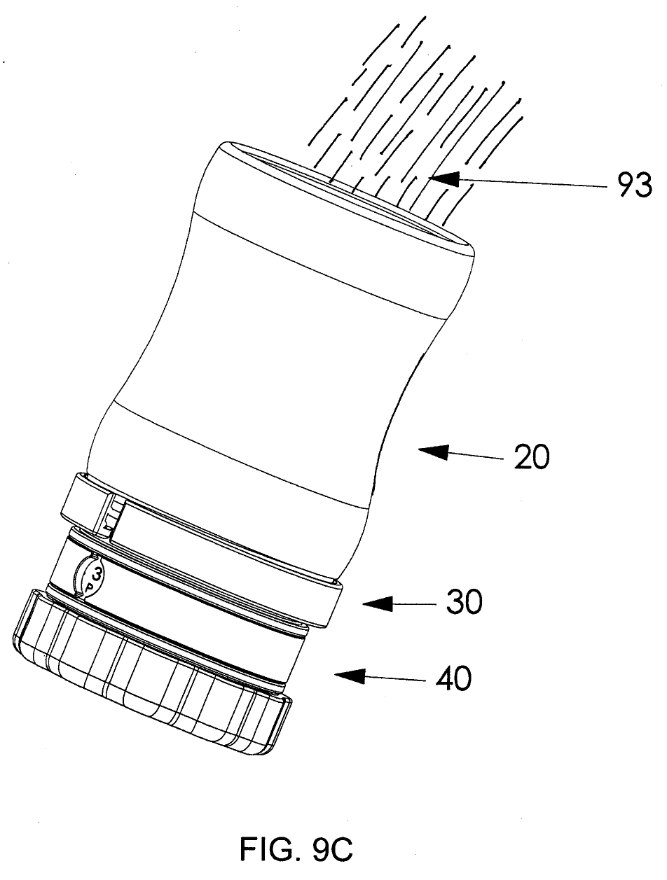

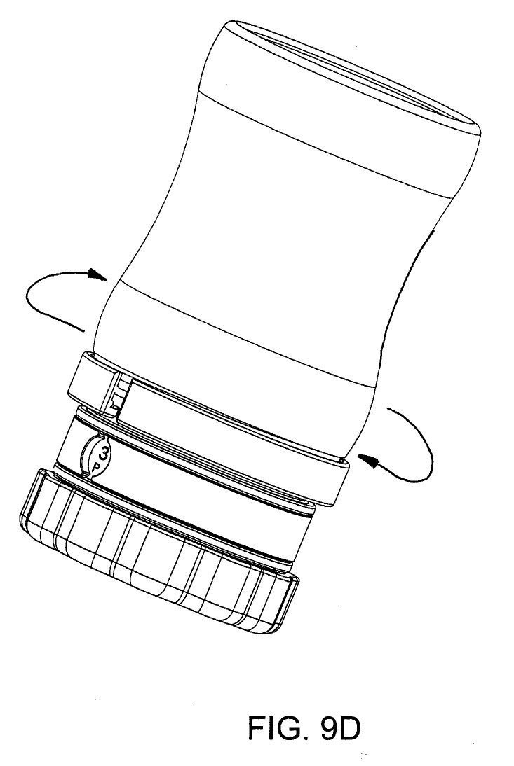

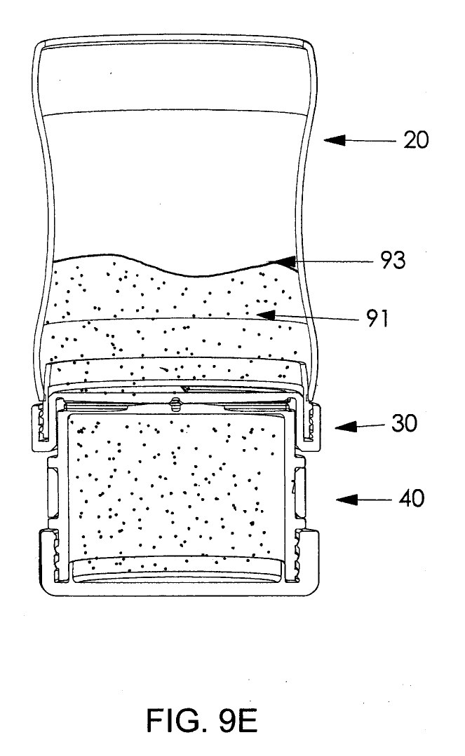

The above-described method allows for mixing without wetting the inside of the lower container 40. In an alternative method of use, wetting the inside of the lower container 40 may occur. This is shown in FIGS. 9A-9E. In FIG. 9A, a dry material 91 is added to an intermediate coupler 30/lower container 40 sub-combination which has been rotated to a closed position. Then the cap 60 is screwed on to close the bottom of the lower container. In the partial view of FIG. 9B the upper container 20 is screwed onto the intermediate coupler 30. Then, when in an upright position, as shown in FIG. 9C, a desired liquid 93 is added to the upper container 20. The top is then sealed (not shown), such as by threading on a desired top with a dispenser (see FIGS. 1 and 7 as examples). Then at the desired time of mixing the so-assembled stacked-container bottle 10, which is maintained in an upright position as shown in FIG. 9D, a user holds the lower container 40 with one hand in this position and rotates the upper container 20 and the intermediate coupler 30 to align an intermediate coupler aperture with that top surface aperture to open a passage as shown in FIG. 5A. The liquid 93 then falls through the passage(s) shown in FIG. 5A and wets the dry material 91 in the lower container 40. While in this open position the bottle 10 may be shaken or otherwise agitated to mix the dry material 91 with the liquid 93.

FIG. 9E shows the mixing of dry material 91 with liquid 93 in both the upper container 20 and the lower container 40. As desired in various embodiments, after a period the bottle 10 may be inverted and the passage(s) closed by rotation to a closed position, so that the liquid mixture remains in the upper container 20. This allows for removal and/or replacement of the lower container 40, such as with an additional amount of dry material. The lower container 40 may be loaded with the desired amount of liquid or powder mix through the bottom opening and then screwed to the bottle 10 via the coupler (see FIG. 2), and the container's apertures and the coupler's apertures may be completely offset with respect to one another, i.e., in the closed position, preventing communication of material between the bottle and sealing the powder container. After screwing both containers together the bottle (top container) is filled with the desire amount of liquid. At the desired time of mixing the powder container will be turned manually and openings would be aligned letting the liquid substances and the powder to mix. Then the user will shake the container and set the time indicator ring to the time when both substances where mixed.

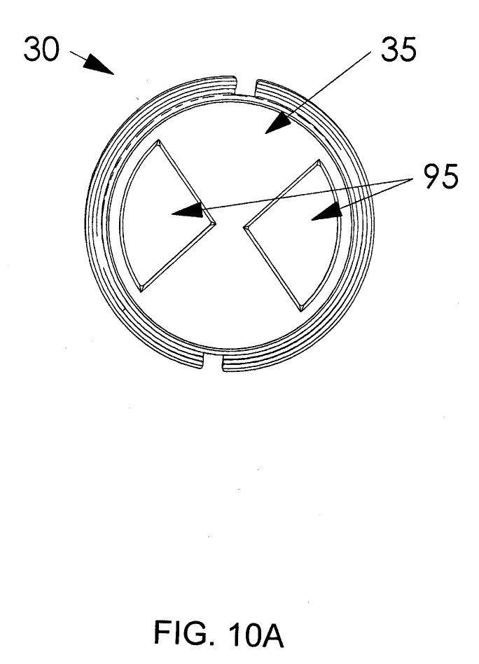

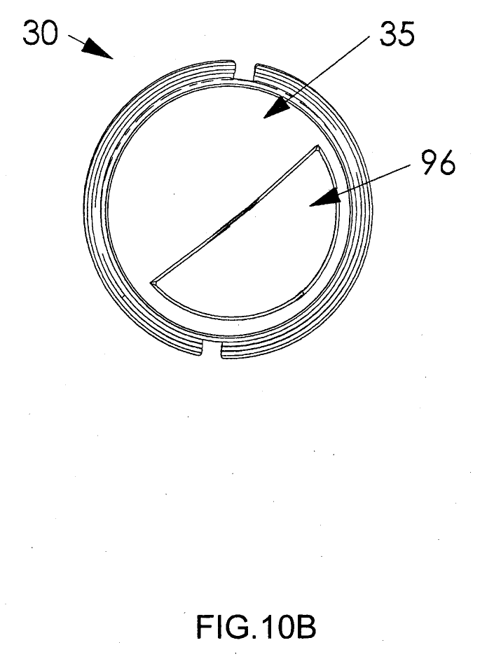

It is noted that when a relatively large quantity of dry material is to be added by the method of FIGS. 8A-F, it may be desirable to have a relatively larger aperture for adding this material into the upper container from the lower container. For comparison, FIG. 10A provides a partial view of the aligned apertures of the sub-combination shown in FIG. 1 and in FIG. 3A, comprising the lower container 40 press fit with the intermediate coupler 30. This shows two passages 95 each formed by the alignment of apertures 33 and 47, each passage occupying less than one-fourth of the area within the plate 35 of the intermediate coupler 30. In this view features of the lower container 40 are not readily viewable.

When the embodiment of FIG. 10A is used with a dry mix according to the method of FIGS. 8A-F, some of the dry material may remain along edges beyond the relevant lower passage through which the dry material is passing (see FIG. 8D). In contrast, FIG. 10B provides an overhead view of aligned apertures of an alternative embodiment in which a single passage 96 is provided both in a lower container and an associated intermediate coupler. These larger single passages, e.g., occupying nearly one-half or more of the area within the plates, would affect passage of more dry material with less material remaining in the lower container.

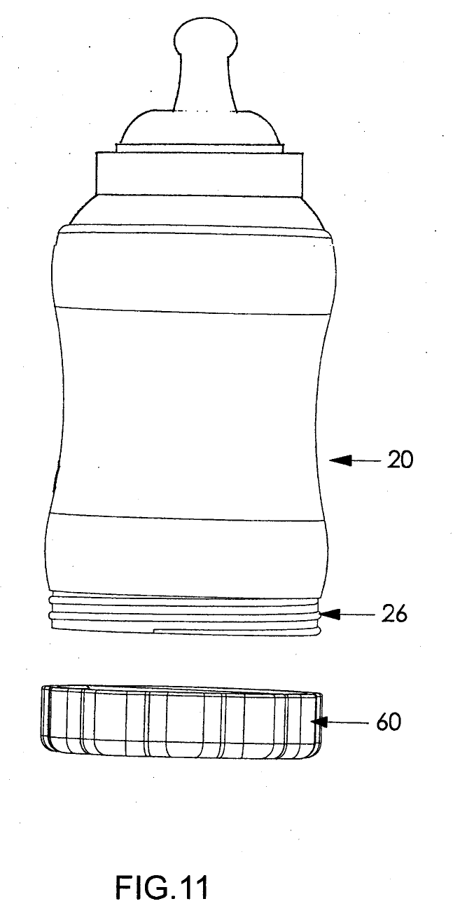

In some embodiments the intermediate coupler 30 may be fixedly attached, such as by a press fit, with the upper container 20 instead of the lower container 40. FIG. 7 may be perceived to depict this if the upper container 20 were press fit with the intermediate coupler 30 and the latter would reversibly attach to the lower container 40. For systems using such embodiments, the lower container is reversibly screwed onto, or otherwise attached to the sub-combination comprising the upper container and the intermediate coupler. A screw-on lid (similar to the bottom cap 60) may be used to keep the lower container sealed until attachment to the intermediate coupler of this sub-combination. Further, as depicted in FIG. 11, when the diameter and thread size of the bottom ends of the upper and lower containers are made consistent in a particular embodiment, the bottom cap 60 of such embodiment may be used to attach directly to bottom threaded end 26 of the upper container 20. The lower container 40 is not shown in FIG. 11. This provides added flexibility in use of the device and system of the present invention.

In addition to embodiments disclosed herein, other features and aspects may be added to the novel structures disclosed herein that fall within the spirit and scope of the present invention. For example, embodiments may be provided for a disposable bottle in which the upper container 20, the intermediate coupler 30, and the lower container 40 are provided as one integrated piece. In such case ports would be provided for filling each of the upper and lower containers 20 and 40, such as are exemplified in FIG. 1 by 28 and 60. Also, FIG. 7 may be perceived to depict this if the upper container 20 were press fit with the intermediate coupler 30 and the latter was also press fit or otherwise non-reversibly affixed to the lower container 40.

As described above the bottle may be equipped with a lower container for dry material and a time indicator device. This container allows the consumers of the product to mix a liquid or a powder substance present in the lower container 40 with liquid present in the upper container 20 of the bottle at a specific and desired moment and to keep the exact time of preparation in order to assure use of the product only when it is fresh and safe for the consumer. The time indicator ring is easy to read visually on the outside of the bottle in order to monitor lapsed time relative to the exact time when the mixing of the perishable substance occurs. Another feature of the disclosed embodiments is that the lower container 40 can be of sufficient size to store food material other than that used for mixing with liquid in the upper container 20, such as cereals, cookies, fresh vegetables, etc. This is possible when the diameter of the bottom cap is sized to receive the food material. Further, an exemplary capacity of the lower container 40 is on the order of 4 to 6 ounces while the capacity of the upper container 20 may be, for example, 9 or more ounces.

Based on potential uses of the bottle 10, the following features are desirable for various embodiments:

a.—All components are non-toxic,

b.—The assembled product is suitable for use in a microwave oven,

c.—The assembled product is suitable for use in boiling water.

d.—The time indicator is reliable, accurate and easy to read,

e.—The bottle has a friendly and easy to use mechanism for storing and mixing of material.

f.—The entire product is dishwasher safe and

g.—The design does not increase significantly the cost compared to regular bottle.

In various embodiments a system comprising the stacked-container bottle of the present invention comprises a reusable bottle with two separate storage containers one for a liquid substance and the other one for powder. The liquid is stored on the top container and the powder is stored in the bottom container as shown in FIG. 2. The upper container consists of a bottle with an opened bottom and a threaded edge that receives the lower container, adapted to contain a liquid or a dry material, by screwing onto the intermediate coupler.

In various embodiments bottle components are made of recyclable plastic, such as polycarbonate, providing an environmentally conscious design. The materials may be selected to be dishwasher safe and are easily cleaned. The polymers (plastics) utilized may be of the high impact variety, and the materials used for the seal components may be non-toxic and hypoallergenic. The design provides a sanitary method for storing and mixing two substances, such as water and powdered baby formula, which overcomes the problems associated with prior art containers. In addition, rotating action about a central axis allows for a simple and inexpensive design. The bottle is equipped with a lower container suitable for liquid or powder storage and a time indicator device. The lower container allows consumers of the product to mix a materials at desired times and to keep a record of the exact time of preparation in order to avoid contamination of the product and to keep it fresh and safe for the consumer.

Although the above discussion has repeated recited advantages of the device, method and system when there is a liquid to be mixed with a dry material, the dry material placed in the lower container, it is appreciated that the device, method and system may also be utilized when liquids rather than any dry materials are placed in both the upper and lower containers. This mixing may desired to bring two liquid chemicals, or chemical solutions together after being held apart for a period of time. The sealing in embodiments of the present invention, which may be a hermetic seal, would allow for such use. Also, liquids in the lower container may include liquid nutrient supplements, medicinal solutions, and the like, that are to be mixed with a liquid in the upper container, such as water or milk, at a desired time after being kept separate in the respective lower and upper containers. Advantageously, with a seal resulting at the interface between the plate 35 and the surface 45, it is possible to retain liquid in the upper container 20 and liquid or dry mix in the lower container 40 without passage of either into the other container, this enabling the user to dispense liquid from the upper container without any mixing with material present in the lower container.

All patents, patent applications, patent publications, and other publications referenced herein are hereby incorporated by reference in this application in order to more fully describe the state of the art to which the present invention pertains, to provide such teachings as are generally known to those skilled in the art, and where indicated to provide specific teachings.

According to one embodiment, a multi-chambered container assembly includes a two-piece adapter having a base and a hollow member that cooperate to open and close a passage between a first chamber provided by a bottle and a second chamber formed in the hollow member. The base defines a first opening and has a substantially semi-spherical concave wall surrounding the first opening, and the hollow member includes a substantially semi-spherical convex wall that pivotally (slidably) fits within the concave wall of the base. The hollow member is snap-coupled to the base using a pair of pins and a pair of cam grooves that facilitate movement of the hollow member between a closed (first) position and an open (second) position. The base can be integrally formed onto the bottle to provide a two-piece multi-chambered container.

Further, embodiments of the invention may be systems that include at least one upper container, at least one lower container, an intermediate coupler affixed to one of the at least one upper container or at least one lower container, and reversibly attach to the other, and including two or more of the containers to which the intermediate coupler does not affix (e.g., press fit). Such systems allow for providing multiple interchangeable containers that may contain a dry material, for example, pre-measured infant formula. Embodiments also include methods comprising the steps as described above and other sub-combinations comprising an intermediate coupler affixed to one of an upper container or a lower container.

While various embodiments of the present invention have been shown and described herein, such embodiments are provided by way of example only. Numerous variations, changes and substitutions may be made without departing from the invention herein. Accordingly, the invention is only limited by the claims which now follow.

The claimed invention is:

1. A multi-chamber container assembly suitable for containing and combining components of a mixed drink and dispensing the mixed drink therefrom, wherein a first drink component is a relatively large volume of liquid and a second drink component is a quantity of mixing material occupying a volume smaller than that of the relatively large volume of the liquid, comprising:
an upper container portion having first and second ends and having capacity for holding the relatively large volume of liquid;
a dispensing portion attachable to the first end of the upper container portion and including a dispensing outlet;
a lower container portion, suitable for receiving the quantity of mixing material, but only having capacity for holding volumes smaller than the capacity of the upper container portion for holding the relatively large volume of liquid; and
an intermediate coupler comprising a first plate having at least one first aperture, the coupler configured for connection between the upper and lower container portions and when connected, the coupler configured for rotation with respect to one of the upper and lower container portions, the coupler being reversibly attachable to the other of the upper and lower container portions, wherein the one of the upper container and lower container portions comprises a second plate having at least one second aperture and wherein the first and second plates are rotatably displaceable with respect to one another as the intermediate coupler is rotated, providing (i) a first rotating position wherein the first aperture of the intermediate coupler is aligned with the second aperture to provide passage between the upper and the lower container portions, and (ii) a second rotating position wherein the first aperture of the intermediate coupler is offset with respect to the second aperture, to provide a barrier preventing passage of liquid from the upper container portion to the lower container portion, and when the container is assembled: the upper container portion provides a relatively large volume capacity to hold the unmixed liquid while the lower container portion provides a volume capacity smaller than the large volume capacity to hold the mixing material, and when a first volume of unmixed liquid is placed in the upper container portion and a second volume of mixing material is placed in the lower container portion, with the first and second plates in the second rotating position, the first and second apertures are offset with respect to one another, this configuration permitting unmixed liquid in the upper container portion to be dispensed through the dispensing portion without contacting the mixing material and (iii) with the first and second plates in the first rotating position, the first and second apertures are aligned, this alternate configuration permitting passage of the mixing material from the lower container portion to the upper container portion.

2. The container of claim 1, further including a seal positioned between the first and second plates, wherein provision of the barrier, preventing passage of liquid from the upper container portion to the lower container portion while the coupler is in the second rotating position, is effected by a combination of the first aperture being offset with respect to the second aperture and the seal being positioned against the first and second plates.

3. The container of claim 2 wherein the first plate includes a surface bound by a perimeter with a seal member groove formed both along the perimeter and around the first aperture, the seal positioned in and extending outward from the groove to effect stable positioning of the seal against the first and second plates.

4. The container of claim 3 wherein the seal member includes an O-ring shape and is formed of hypoallergenic material.

5. The container of claim 1 wherein, when fully assembled, the combination of the dispensing portion, the upper container portion and the intermediate coupler define the relatively large volume capacity for holding the unmixed liquid.

6. The container of claim 1 wherein the dispensing portion includes a sports cap as the dispensing outlet.

7. The container of claim 1 configured so that dry material placed in the lower container portion can be mixed with liquid placed in the upper container portion without wetting the lower container portion.

8. The container of claim 1 further including a rotatable time indicator ring device formed on the lower container portion suitable for recording and viewing a time at which materials placed in the upper and lower container portions are mixed.
